(19) United States
(12) Patent Application Publication
(10) Pub. No.: US 2013/0276532 A1
(43) Pub. Date: Oct. 24, 2013

(54) LEVEL MEASURING DEVICE

(71) Applicant: Aisan Kogyo Kabushiki Kaisha, (US)

(72) Inventor: Nobuhiro Kato, Aichi-ken (JP)

(21) Appl. No.: 13/845,380

(22) Filed: Mar. 18, 2013

(30) Foreign Application Priority Data
Mar. 29, 2012 (JP) 2012-077913
Feb. 5, 2013 (JP) 2013-020289

(51) Int. Cl. G01F 23/26

(52) U.S. Cl. CPC G01F 23/263
USPC 73/304 C

(57) ABSTRACT

A liquid level measuring device may comprise a fuel tank that stores fuel, a fuel pump that sucks the fuel in the fuel tank and pumps the fuel toward a combustion apparatus, a fuel discharging portion that discharges the fuel from the fuel pump into the fuel tank, a ease that receives the fuel discharged from the fuel discharging portion and a pair of liquid level-sensitive electrodes that is accommodated in the case so as to measure capacitance that changes with the liquid level. The case may have a fuel permeating property to equalize the liquid level inside the case and the liquid level outside the case.

### CROSS-REFERENCE TO RELATED APPLICATIONS

This application claims priority to Japanese Patent Application No. 2012-077913, filed on Mar. 29, 2012 and Japanese Patent Application No. 2013-020289, filed on Feb. 5, 2013, the contents of which are hereby incorporated by reference into the present application.

### TECHNICAL FIELD

The present specification discloses a device for measuring the level of fuel stored in a fuel tank.

### DESCRIPTION OF RELATED ART

As disclosed in Japanese Patent Application Publication No. 2005-351688, Japanese Patent Application Publication No. 2006-38497, and Japanese Patent Application Publication No. 2007-240262, a technique of disposing a pair of electrodes in a fuel tank and measuring the capacitance of the pair of electrodes to thereby measure a liquid level has been developed. In this technique, a pair of electrodes that extends in a vertical direction from a lowest liquid level to a highest liquid level within a fuel tank is disposed in the fuel tank. A portion of the pair of electrodes located under an actual liquid level is immersed in fuel and a portion located above the actual liquid level is exposed from the fuel. The capacitance of the pair of electrodes is determined by the capacitance of the immersed portion and the capacitance of the exposed portion. Since the permittivity of fuel is different from the permittivity of atmosphere, the capacitance of the pair of electrodes changes according to the liquid level. Thus, the liquid level can be measured from the capacitance of the pair of electrodes.

### SUMMARY

Alcohol blended fuel has recently come into wide use. In the case of alcohol blended fuel, an alcohol content is not constant. Thus, immediately after alcohol blended fuel is supplied, the alcohol content in the fuel is distributed inhomogeneously according to locations within the fuel tank.

In the technique of measuring the liquid level from the capacitance of a pair of electrodes, the permittivity of fuel in the portion where the pair of electrodes is immersed in the fuel being the same is regarded as a premise. If the permittivity of fuel in the immersed portion of the pair of electrodes is distributed inhomogeneously in the depth direction, the process of converting a capacitance into a liquid level is different from an actual process. The permittivity of alcohol blended fuel changes depending on the alcohol content. Since the permittivity of fuel is distributed inhomogeneously in the depth direction immediately after alcohol blended fuel is supplied, the measured liquid level problematically becomes different from the actual liquid level.

Although this problem typically occurs when the fuel is alcohol blended fuel, the fuel is not limited to alcohol blended fuel. The permittivity of fuel changes according to the quality of fuel. Even when fuel of the same specification is supplied, a phenomenon in which a subtle difference occurs in the fuel quality occurs. For fuels other than alcohol blended fuel, immediately after fueling, a phenomenon in which the quality (i.e., permittivity) of fuel is distributed inhomogeneously according to the locations within the fuel tank occurs.

In Japanese Patent Application Publication No. 2005-351688, Japanese Patent Application Publication No. 2006-38497, and Japanese Patent Application Publication No. 2007-240262, the phenomenon in which the quality of fuel stored in a fuel tank is distributed inhomogeneously according to the locations within the fuel tank is not taken into consideration. Moreover, an error which may be included in the liquid level measurement result due to the phenomenon is not also taken into consideration. In Japanese Patent Application Publication No. 2005-351688 and Japanese Patent Application Publication No. 2006-38497, since only a pair of liquid level-sensitive electrodes is provided within the fuel tank, when the quality of fuel is distributed inhomogeneously according to the locations within the fuel tank, an error may be included in the liquid level measurement result.

Japanese Patent Application Publication No. 2007-240262 discloses a technique of measuring a liquid level using two pairs of liquid level-sensitive electrodes without depending on the permittivity of fuel. In this technique, when the quality of fuel is distributed inhomogeneously according to the locations within the fuel tank, an error may be also included in the liquid level measurement result.

The present application discloses a technique capable of measuring the liquid level in a fuel tank even when quality of fuel changes according to locations within the fuel tank.

The present application discloses a liquid level measuring device for measuring a liquid level of fuel stored in a fuel tank. The liquid level measuring device may comprise the fuel tank that stores fuel, a fuel pump that sucks the fuel in the fuel tank and pumps the fuel toward a combustion apparatus, a fuel discharging portion that discharges the fuel from the fuel pump into the fuel tank, a case that receives the fuel discharged from the fuel discharging portion and a pair of liquid level-sensitive electrodes that is accommodated in the case so as to measure capacitance that changes with the liquid level. The case may have a fuel permeating property to equalize the liquid level inside the case and the liquid level outside the case.

In the above measuring device, since the fuel that is stirred by the fuel pump and discharged from the fuel discharging portion is received in the case, the fuel in the case is quickly homogenized. Since the pair of liquid level-sensitive electrodes is accommodated in the case, the fuel in which the pair of liquid level-sensitive electrodes is immersed is homogenized in the depth direction. Since the process of converting the capacitance into the liquid level is identical to an actual process, the error included in the liquid level measurement result may be reduced.

Further, the present application discloses another liquid level measuring device for measuring a liquid level of fuel stored in a fuel tank. The liquid level measuring device may comprise a fuel pump that sucks the fuel in the fuel tank and pumps the fuel toward a combustion apparatus, a fuel discharging portion that discharges the fuel from the fuel pump into the fuel tank, a case that receives the fuel discharged from the fuel discharging portion and a pair of liquid level-sensitive electrodes that is accommodated in the case so as to measure capacitance that changes with the liquid level. The case may have a fuel permeating property so that the liquid level inside the case and the liquid level outside the case are equalized.

According to this configuration, the fuel in which the pair of liquid level-sensitive electrodes is immersed is homogenized in the depth direction. Since the process of converting the capacitance into the liquid level is identical to an actual process, the error included in the liquid level measurement result may be reduced.

### BRIEF DESCRIPTION OF DRAWINGS

FIG. 1 shows a configuration around a fuel tank according to a first embodiment.

FIGS. 2A and 2B show a pattern of a pair of liquid level-sensitive electrodes and a pair of liquid level-insensitive electrodes according to the first embodiment.

FIGS. 3A to 3C show a side wall of a case according to the first embodiment.

FIG. 4 shows a cross section of a liquid level sensor substrate and the case according to the first embodiment.

FIG. 5 shows a configuration around a fuel tank according to a second embodiment.

FIG. 6A shows a configuration around a fuel tank according to a sixth embodiment.

FIG. 6B shows a pattern of a pair of electrodes according to the sixth embodiment.

FIG. 7 shows a configuration around a fuel tank according to a fourth embodiment.

FIG. 8 shows a cross section of a liquid level sensor substrate and a case according to the fourth embodiment.

FIG. 9 shows a pattern of a pair of liquid level-insensitive electrodes according to the fourth embodiment.

FIG. 10 shows a pattern of a pair of liquid level-sensitive electrodes according to the fourth embodiment.

FIG. 11 shows a configuration around a fuel tank according to a fifth embodiment,

FIG. 12 shows a cross section of a liquid level sensor substrate and a case according to the fifth embodiment

FIG. 13 shows a configuration around a fuel tank according to a sixth embodiment.

FIG. 14 shows a cross section of a liquid level sensor substrate and a stirring chamber according to the sixth embodiment.

FIG. 15 shows a cross section of a liquid level sensor substrate and an upper part of the case according to the sixth embodiment.

FIG. 16 shows a configuration around a fuel tank according to a seventh embodiment.

FIG. 17 shows a cross section of a liquid level sensor substrate and a stirring chamber according to the seventh embodiment.

FIG. 18 shows a cross section of a liquid level sensor substrate and an upper part of the case according to the seventh embodiment.

FIGS. 19A and 19B show a pattern of a pair of liquid level-sensitive electrodes and a pair of liquid level-insensitive electrodes according to the seventh embodiment.

FIGS. 20A to 20C show a relationship between the case and the liquid level sensor substrate according to the eighth embodiment.

FIGS. 21A and 21B show a contrast between a thick liquid level sensor substrate and a thin liquid level sensor substrate.

FIG. 22 shows a configuration around a fuel tank according to a ninth embodiment.

FIG. 23 shows a configuration around a fuel tank according to a tenth embodiment.

FIG. 24 shows a configuration around a fuel tank according to a eleventh embodiment.

FIG. 25 shows a configuration around a fuel tank according to a twelfth embodiment.

FIG. 26 shows a configuration around a fuel tank according to a thirteenth embodiment.

FIG. 27 shows a configuration around a fuel tank according to a fourteenth embodiment.

FIG. 28 shows a XXVIII- XXVIII cross section of FIG. 27.

### DETAILED DESCRIPTION

First, some of the features of embodiments described below will be described. The features described herein each independently have technical usefulness.

(Feature 1) The fuel discharging portion may comprise a pressure regulator that is disposed between the fuel pump and the combustion apparatus and that regulates pressure of the fuel pumped toward the combustion apparatus to a predetermined value by discharging surplus fuel. According to this configuration, since the fuel discharged from the pressure regulator is received into the case, the fuel in the case is quickly homogenized. Due to this, an error included in the liquid level measurement result may be reduced.

(Feature 2) The fuel discharging portion may comprise a branch passage that branches off from a fuel supply pipe that supplies fuel from the fuel pump to the combustion apparatus and a decompressing portion that decreases the pressure of the fuel in the branch passage. According to this configuration, since the fuel discharged from the branch passage is received into the case, the fuel in the case is quickly homogenized. Due to this, an error included in the liquid level measurement result may be reduced.

(Feature 3) The fuel discharging portion may comprise a discharge passage that extends from a vapor jet disposed in the fuel pump to the inside of the fuel tank. The vapor jet is used for discharging vapor in the fuel pump, from the fuel pump into the fuel tank. According to this configuration, since the fuel discharged from the vapor jet is received into the case, the fuel in the case is quickly homogenized. Due to this, an error included in the liquid level measurement result may he reduced.

(Feature 4) A pair of liquid level-insensitive electrodes that is immersed in the fuel may be disposed in the case. In the pair of liquid level-sensitive electrodes, although the boundary position of the immersed portion and the exposed portion changes with the liquid level, the pair of liquid level-insensitive electrodes is normally immersed in the fuel and is not exposed from the fuel even when the liquid level decreases. Accordingly, the permittivity of fuel necessary when converting the measurement value obtained using the pair of liquid level-sensitive electrodes into a liquid level may be measured within the case. The pair of liquid level-sensitive electrodes is immersed in fuel that is homogenized with the fuel of which the penitivity is measured.

(Feature 5) A penetration hole may be formed a wall that defines the case. The penetration hole may extend continuously or intermittently in a vertical direction. In the latter case, a plurality of penetration holes is arranged at intervals in the vertical direction. Due to the penetration hole or the penetration holes, the liquid levels inside and outside the case are maintained to be the same.

(Feature 6) A penetration hole may be formed in the vicinity of upper and lower ends of the case. Due to this, the liquid levels inside and outside the case are maintained to be the same due to the upper and lower penetration holes.

(Feature 7) A wall that defines the case may be formed of a material that has fuel permeating property (e.g., a filter). Due to this, the liquid levels inside and outside the case are maintained to be the same due to the fuel permeating property of the case wall.

(Feature 8) The case may communicate with a filter that filters the fuel sucked into the fuel pump. That is, fuel circulation in which the fuel delivered to the case through the fuel pump and the pressure regulator flows out of the case to flow into the filter and is then sucked into the fuel pump is developed. Thus, the homogenization of the fuel inside the case is accelerated.

(Feature 9) The pair of liquid level-insensitive electrodes may be disposed in the filter. In this case, since circulation of vapor is realized, the homogeneity of the fuel being in contact with the pair of liquid level-sensitive electrodes and the fuel being in contact with the pair of liquid level-insensitive electrodes and the homogeneity of the fuel being in contact with the pair of liquid level-sensitive electrodes extending in the depth direction are secured. Thus, the liquid level measurement accuracy is further improved.

(Feature 10) An interference wall may be disposed between the pair of liquid level-sensitive electrodes and a position at which the fuel discharged from the fuel discharging portion flows into the case. The interference wall may be formed of a material that has a fuel permeating property. Bubbles may be included in the fuel discharged from the pressure regulator. When the interference wall is disposed, the fuel discharged from the pressure regulator will not directly come into contact with the pair of liquid level-sensitive electrodes. The pair of liquid level-sensitive electrodes is immersed in the fuel from which bubbles are removed. Thus, an error resulting from the bubbles may be prevented from being included in the liquid level measurement result.

(Feature 11) A stirring chamber that receives the fuel discharged by the fuel discharging portion and mixes the fuel with the fuel inside the case may be formed in a portion of the case. The use of the stirring chamber allows the fuel in the case to be quickly homogenized in a case where an engine is started immediately after fueling. Thus, an accurate liquid level may be measured in a short time.

(Feature 12) Edges in a horizontal direction of a component in which the pair of liquid level-sensitive electrodes is formed may be supported by the case. For example, when a groove extending in the vertical direction is formed in the case, the left and right edges of the component are inserted in the groove whereby the left and right edges of the component are fixed to the case. Alternatively, the case may be configured to be divided into two parts along a division line that extends in the vertical direction, and the left and right edges of the component may be inserted between both parts. In the latter case, a substrate in which the pair of liquid level-sensitive electrodes is formed may be made as thin as a flexible film. When the substrate in which the pair of liquid level-sensitive electrodes is formed is made thin, the lines of electric field that determines the capacitance which is a measurement target spread out into the fuel present on the front side of the film and the fuel present on the rear side of the fuel. When the substrate in which the pair of liquid level-sensitive electrodes is formed is made thin, the measurement sensitivity of the pair of liquid level-sensitive electrodes increases.

(Feature 13) A member that has an electromagnetic shielding function may be surrounded the pair of liquid level-sensitive electrodes The member having the electromagnetic shielding function may be a metallic cylinder, a resin cylinder of which the inner or outer surface is plated with metal, or a resin cylinder of which the inner or outer surface is coated with metal-containing paint or metal-containing ink. When the pair of liquid level-sensitive electrodes is accommodated in these cases, ambient electromagnetic noise is electromagnetically shielded and is prevented from affecting the liquid level measurement result.

(Feature 14) The liquid level measuring device may further comprise a reserve cup that is disposed in the fuel tank so as to accommodate the fuel pump, a first flow passage that discharges the fuel discharged from the fuel discharging portion into the reserve cup and a second flow passage that extends from the fuel discharging portion to the case. According to this configuration, homogenized fuel into the reserve cup may be supplied.

(Feature 15) The liquid level measuring device may further comprise a stop valve that is disposed in the first flow passage. According to this configuration, the fuel supplied from the first flow passage to the reserve cup may be controlled.

(Feature 16) The liquid level measuring device may further comprise a reserve cup that is disposed in the fuel tank so as to accommodate the fuel pump, a jet pump that delivers the fuel outside the reserve cup into the reserve cup by utilizing a flow rate of the fuel discharged from the fuel discharging portion, a third flow passage that extends from the fuel discharging portion to the case and a fourth flow passage that extends from the fuel discharging portion to the jet pump. According to this configuration, it is not necessary to provide a new configuration for delivering fuel to the jet pump. Moreover, the flow passage for delivering fuel to the jet pump and the flow passage for delivering fuel to the measurement fuel storage chamber may be provided separately. Due to this, it is possible to individually regulate the pressure of the fuel delivered to the jet pump and the pressure of the fuel delivered to the case.

(Feature 17) The liquid level measuring device may farther comprise a flow passage regulating portion that is disposed in at least one of the third flow passage and the fourth flow passage and comprises at least one of a valve and an aperture. According to this configuration, the fuel flowing through the flow passage in which the flow passage regulating portion is disposed may be controlled. For example, when the flow passage regulating portion is disposed in the third flow passage, a decrease in the pressure of the fuel delivered to the jet pump may be suppressed. On the other hand, for example, when the flow passage regulating portion is disposed in the fourth flow passage, fuel to the case preferentially nay be supplied.

(Feature 18) The combustion apparatus is not particularly limited and typically corresponds to an. engine,

(Feature 19) The liquid level measuring device may further comprise an electronic circuit outputting a voltage or a current proportional to a capacitance of the pair of liquid level-sensitive electrodes. The electronic circuit may output a voltage or a current proportional to a liquid level converted from the capacitance of the pair of liquid level-sensitive electrodes.

Representative, non-limiting examples of the present invention will now he described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved level measuring devices, as well as methods for using the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

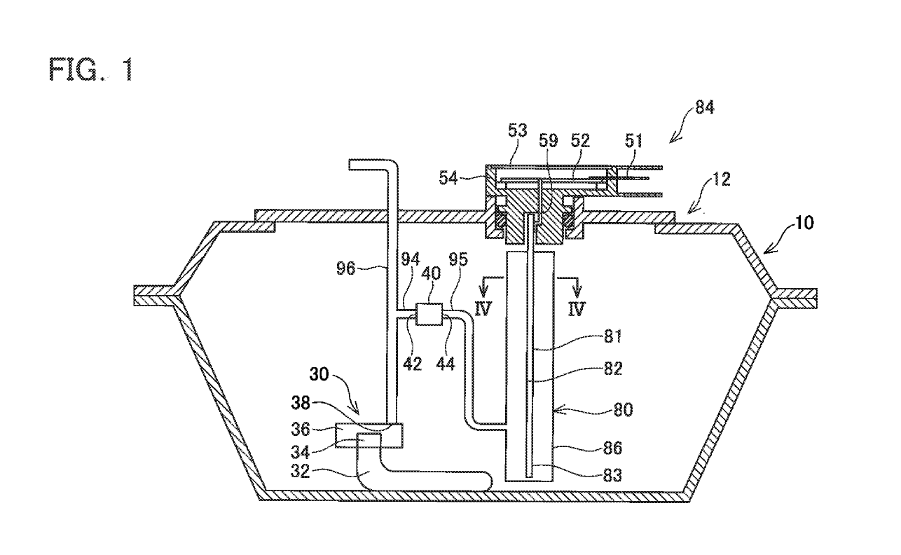

FIG. 1 shows a configuration around a fuel tank according to the first embodiment. A fuel pump 30 is accommodated in a fuel tank 10. The fuel pump 30 is configured such that fuel filtered by a low pressure filter 32 is sucked into a pump body 34, the sucked fuel is filtered by a high pressure filter 36, and the filtered pressurized fuel is delivered from an outlet port 38. A pipe 94 is connected to the outlet port 38, and an inlet port 42 of a pressure regulator 40 is connected to the pipe 94. The pressure regulator 40 comprises a valve which allows the inlet port 42 and the outlet port 44 to communicate with each other when the pressure of the inlet port 42 becomes a predetermined value or more. When the pressure of the inlet port 42 becomes the predetermined value or smaller, the valve is closed so that the inlet port 42 and the outlet port 44 do not communicate with each other. The pressure regulator 40 regulates the pressure of the inlet port 42 and the fuel in the pipe 94 to be constant by discharging surplus fuel from the outlet port 44. A pipe 96 branches of from the pipe 94, and the pipe 96 is connected to an engine via a delivery pipe and an injector. The fuel in the fuel tank 10 is pumped to the engine with the pressure regulated to be constant by the fuel pump 30 and the pressure regulator 40.

A pipe 95 is connected to the outlet port 44 of the pressure regulator 40, and a liquid level measuring device 80 is connected to the pipe 95. The liquid level measuring device 80 comprises a liquid level sensor substrate 82 in which a pair of liquid level-sensitive electrodes 81 is formed, an electronic circuit portion 84 that is connected to the liquid level sensor substrate 82 so as to measure the capacitance of the pair of liquid level-sensitive electrodes 81, convert the capacitance into a liquid level, and output a voltage proportional to the converted liquid level, and a case 86 that accommodates the liquid level sensor substrate 82. The fuel discharged from the outlet port 44 of the pressure regulator 40 is delivered into the case 86. The case 86 has filled permeating property which is not depicted in FIG. 1, and the liquid level inside the case 86 is the same as the liquid level (that is, the liquid level inside the fuel tank 10) outside the case 86. Fuel that is stirred by the fuel pump 30 and discharged from the pressure regulator 40 is introduced into the case 86, and the fuel in the case 86 is homogeneous. The pair of liquid level-sensitive electrodes 81 is immersed in the homogeneous fuel within the case 86.

A pair of liquid level-insensitive electrodes 83 is formed at a deep position of the liquid level sensor substrate 82. The pair of liquid level-insensitive electrodes 83 is normally immersed in the fuel, and the permittivity of the fuel can be measured from the capacitance of the electrodes. The pair of liquid level-sensitive electrodes 81 and the pair of liquid level-insensitive electrodes 83 are both accommodated in the case 86, and the fuel in which the pair of liquid level-sensitive electrodes 81 is immersed is homogeneous with the fuel in which the pair of liquid level-insensitive electrodes 83 is immersed.

The electronic circuit portion 84 comprises a sensor body 54, a conductive piece 59, a circuit substrate 52, a terminal pin 51, and a lid 53. The conductive piece 59 passes through the sensor body 54 so as to connect the liquid level sensor substrate 82 and the circuit substrate 52. A circuit for measuring the capacitance of the pair of liquid level-sensitive electrodes 81, converting the capacitance into a liquid level, and outputting a voltage proportional to the converted liquid level is mounted on the circuit substrate 52. The terminal pin 51 outputs the voltage proportional to the liquid level. The liquid level sensor substrate 82 is supported by the sensor body 54.

The fuel pump 30, the pressure regulator 40, the liquid level measuring device 80, the pipes 94, 95, and 96, and the like are fixed to the set plate 12. The set plate 12 is fixed to the fuel tank 10 to block the opening of the fuel tank 10. The fuel pump 30, the pressure regulator 40, the liquid level measuring device 80, the pipes 94, 95, and 96, and the like are aligned within the fuel tank 10 by the set plate 12.

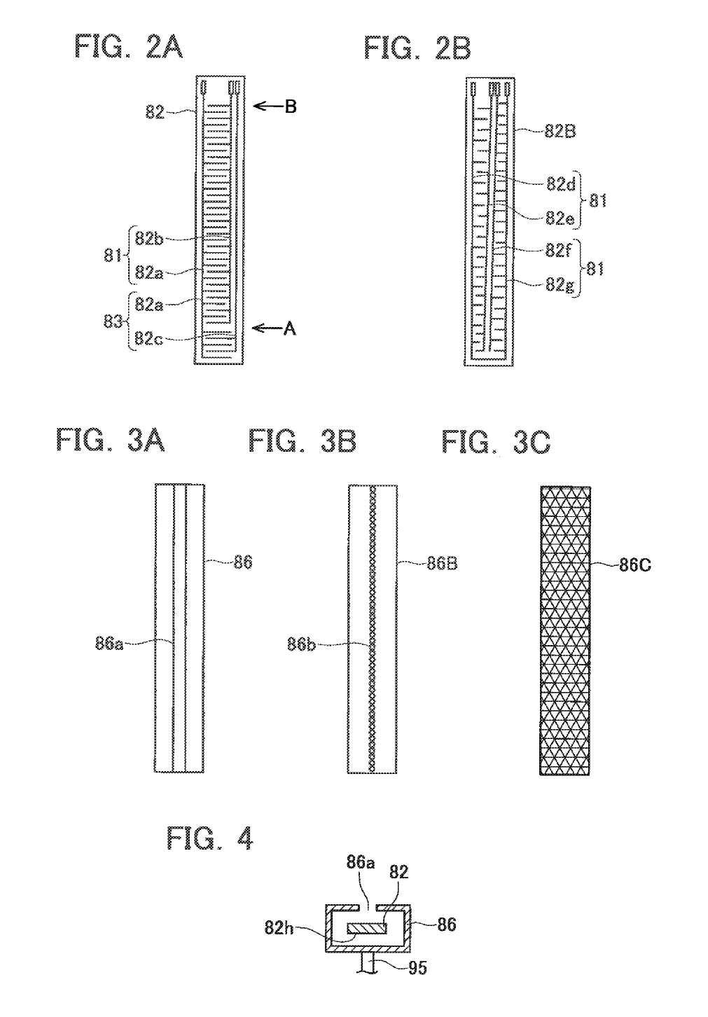

FIG. 2A shows two pairs of electrodes formed on the surface of the liquid level sensor substrate 82. A first pair of electrodes includes a comb-shaped electrode 82a and a comb-shaped electrode 82b, and a second pair of electrodes includes the comb-shaped electrode 82a and a comb-shaped electrode 82c. The comb-shaped electrode 82a is used in common in the first and second pairs of electrodes. The comb-shaped electrode 82b extends in a vertical direction from a lowest liquid level A to a highest liquid level B that are determined in advance for the fuel tank 10, and the comb-shaped electrode 82c is located below the lowest liquid level A. The capacitance of the first pair of electrodes 82a and 82b changes according to the liquid level of the fuel tank 10. The second pair of electrodes 82a and 82c is normally immersed in fuel under normal conditions, and the capacitance thereof does not change according to the liquid level of the fuel tank 10. The first pair of electrodes 82a and 82b is the pair of liquid level-sensitive electrodes 81, and the second pair of electrodes 82a and 82c is the pair of liquid level-insensitive electrodes 83.

The capacitance of the second pair of electrodes 82a and 82c (i.e., the pair of liquid level-insensitive electrodes 83) is determined by the permittivity of fuel. The permittivity of the fuel can be measured from the capacitance of the second pair of electrodes 82a and 82c.

The capacitance of the first pair of electrodes 82a and 82b (i.e., the pair of liquid level-sensitive electrodes 81) is determined by the liquid level and the permittivity of the fuel. The liquid level of the fuel can be measured from the capacitance of the pair of liquid level-sensitive electrodes 81 and the permittivity measured from the capacitance of the pair of liquid level-insensitive electrodes 83. A circuit for executing the conversion process is mounted on the circuit substrate 52.

As described above, since the fuel discharged from the pressure regulator 40 is introduced into the case 86, the fuel in the case 86 is homogenized. The fuel in which the pair of liquid level-insensitive electrodes 83 is immersed is homogeneous with the fuel in which the pair of liquid level-sensitive electrodes 81 is immersed. Further, the fuel in which the pair of liquid level-sensitive electrodes 81 is immersed is homogenized until the fuel level increases from the lowest liquid level A to reach the actual liquid level.

The logic of converting the capacitance of the pair of liquid level-sensitive electrodes 81 into the liquid level is based on an assumption that the fuel in which the pair of liquid level-insensitive electrodes 83 is immersed is homogeneous with the fuel in which the pair of liquid level-sensitive electrodes 81 is immersed, and the fuel in which the pair of liquid level-sensitive electrodes 81 is immersed is homogenized until the fuel level increases from the lowest liquid level A to the actual liquid level. According to the embodiment of FIG. 1, the preconditions of the liquid level conversion logic can be realized.

The pair of liquid level-sensitive electrodes 81 for liquid level measurement may include two pairs of electrodes (i.e., one pair of 82d and 82e and the other pair of 82f and 82g) as shown in FIG. 213. By doing so, capacitance measurement sensitivity is improved.

FIGS. 3A to 3C show the shape of a side wall of the case 86 as seen from the right side of FIG. 1. In FIG. 3A, a slit 86a is formed in the side wall. That is, a penetration hole that extends continuously in the vertical direction is formed. The slit 86a allows the inside of the case 86 to communicate with the outside of the case 86. Since the slit 86a is formed, the liquid level inside the case 86 is the same as the liquid level outside the case 86. The width of the case 86a is sufficiently wide enough to maintain the liquid level inside the case 86 to be the same as the liquid level outside the case 86 and is narrow enough to allow the fuel discharged from the pressure regulator 40 to remain around the liquid level sensor substrate 82 and to homogenize the fuel present around the liquid level sensor substrate 82.

The penetration hole formed in the side wall of the case 86 may be not continuous in the vertical direction. As shown in FIG. 3B, the penetration hole may be formed discontinuously in the vertical direction. That is, a plurality of penetration holes 86b may be arranged at intervals in the vertical direction. This case 86B also allows the liquid level inside the case 86B to be maintained to be the same as the liquid level outside the case 86B and allows the fuel discharged from the pressure regulator 40 to remain around the liquid level sensor substrate 82 to homogenize the fuel present around the liquid level sensor substrate 82.

As shown in FIG. 3C, the side wall of a case 86C may be formed of a fuel permeating material, for example, a material that forms a filter 32. This case 86C also allows the liquid level inside the case 86C to be maintained to be the same as the liquid level outside the ease 86C and allows the fuel discharged from the pressure regulator 40 to remain around the liquid level sensor substrate 82 to homogenize the fuel present around the liquid level sensor substrate 82.

FIG. 4 shows a cross-section of the case 86 and the liquid level sensor substrate 82. The pairs of electrodes 81 and 83 shown in FIGS. 2A and 2B may be formed on a surface 82h closer to the pipe 95 among the front and rear surface of the substrate 82 and may be formed on a surface closer to the slit 86a. The pair of liquid level-sensitive electrodes 81 and the pair of liquid level-insensitive electrodes 83 may he formed on different surfaces. When the pairs of electrodes 81 and 83 are formed on the surface 82h closer to the pipe 95, the fuel being in contact with the pairs of electrodes 81 and 83 are quickly homogenized. When the pairs of electrodes 81 and 83 are formed on the surface closer to the slit 86a, it is possible to prevent bubbles or the like from adhering to the pairs of electrodes 81 and 83.

### Second Embodiment

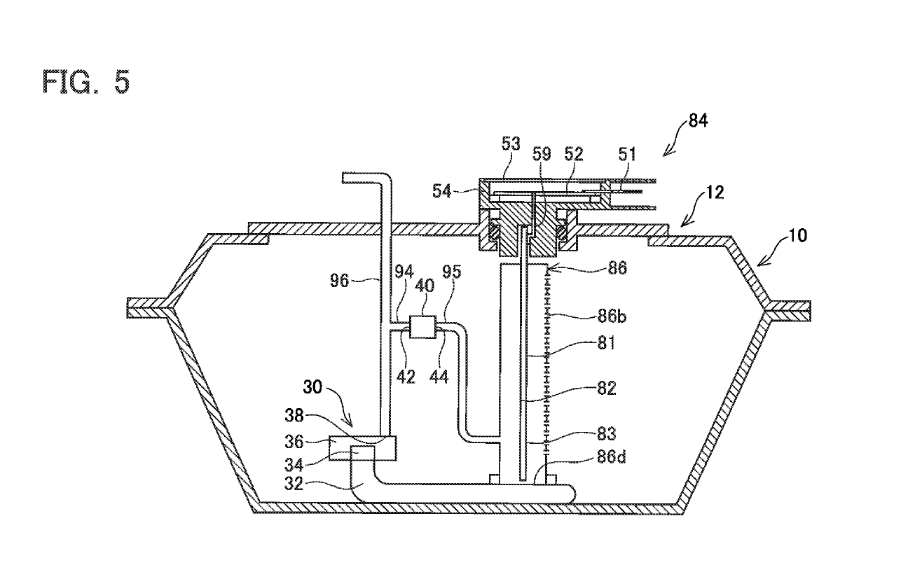

As shown in FIG. 5, in the second embodiment, a bottom 86d of the case 86 that accommodates the liquid level sensor substrate 82 is open, and the case 86 is in contact with the surface of the low pressure filter 32. The penetration holes 86b shown in FIG. 3B are formed in the side wall of the case 86. In this embodiment, it is possible to allow the fuel discharged from the pressure regulator 40 to remain around the liquid level sensor substrate 82 and to homogenize the fuel being in contact with the liquid level sensor substrate 82 until the fuel level increases from the lowest liquid level to reach an actual liquid level.

Moreover, according to the embodiment shown in FIG. 5, fuel circulation in which the fuel delivered to the case 86 through the fuel pump 30 and the pressure regulator 40 flows out of the case 86 to flow into the low pressure filter 32 and is then sucked into the fuel pump 30 is developed. Thus, the homogenization of the fuel inside the case 86 is accelerated.

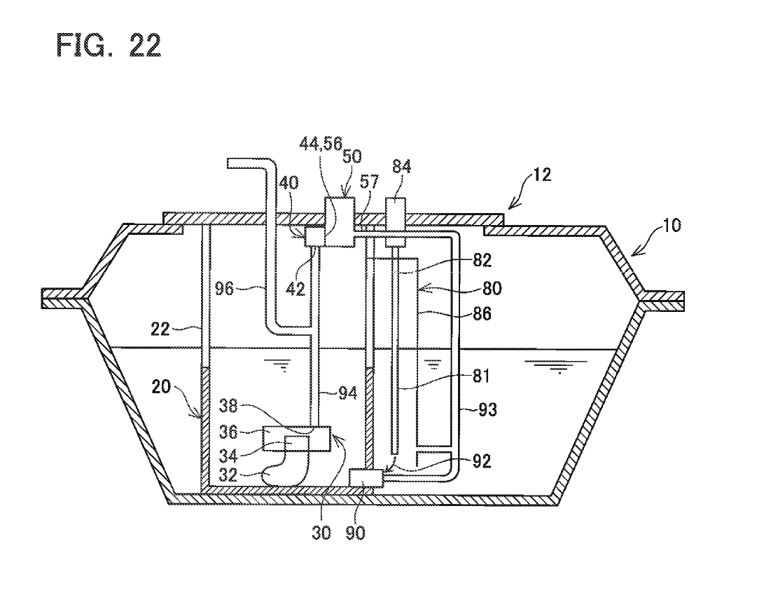

It is not always necessary to provide the pair of liquid level-insensitive electrodes 83 in the case 86. This is because when the pair of liquid level-insensitive electrodes 83 is provided downstream the fuel pump 30, the permittivity of the fuel homogenized with the fuel in which the pair of liquid level-sensitive electrodes 81 is immersed can be measured. As shown in FIG. 22 described later, a permittivity measuring device 50 in which the liquid level-insensitive electrodes 83 are accommodated may be disposed between the pressure regulator 40 and the case 86. In this case, it is sufficient for the case 86 to homogenize the fuel being in contact with the liquid level sensor substrate 82 until the fuel level increases from the lowest liquid level to reach an actual liquid level and to maintain the liquid levels inside and outside the case 86 to be the same.

### Third Embodiment

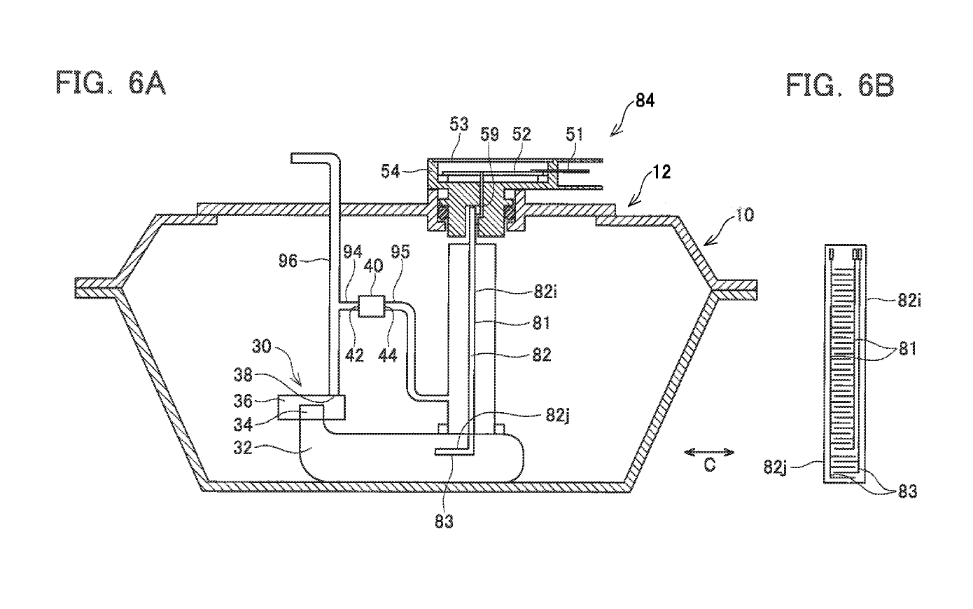

As shown in FIG. 6A, in the third embodiment, the liquid level sensor substrate 82 includes a vertical portion 82i and a horizontal portion 82j. The vertical portion 82i is accommodated in the case 86, and the horizontal portion 82j is accommodated in the low pressure filter 32. As shown in FIG. 6B, the pair of liquid level-sensitive electrodes 81 is formed in the vertical portion 82i, and the pair of liquid level-insensitive electrodes 83 is formed in the horizontal portion 82j. FIG. 6B shows a state where the horizontal portion 82j is placed vertically.

Fuel remains inside the low pressure filter 32 regardless of the liquid level inside the fuel tank 10, and the liquid level-insensitive electrodes 83 formed in the horizontal portion 82j of the liquid level sensor substrate 82 are normally immersed in the fuel. The third embodiment of FIGS. 6A and 6B has the merits of the first and second embodiments.

### Fourth Embodiment

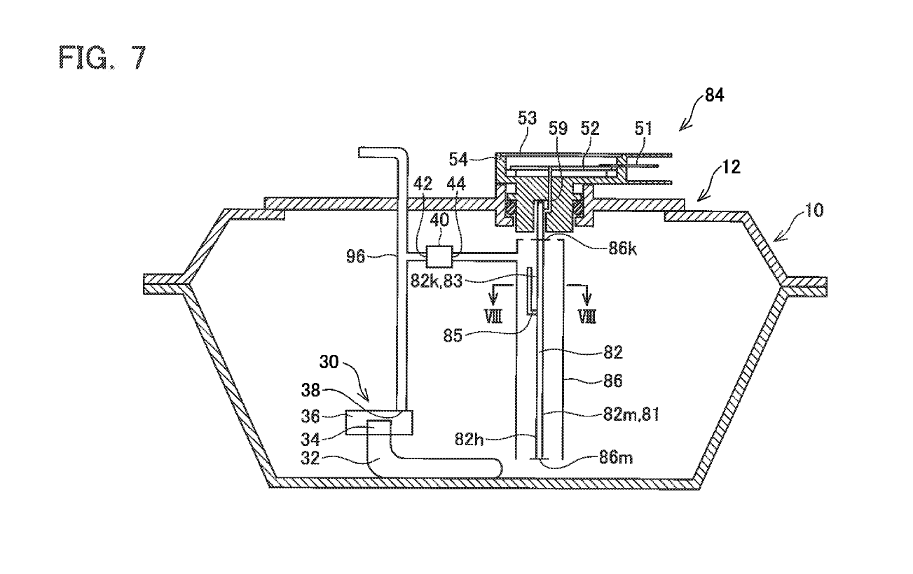

As shown in FIG. 7, in the fourth embodiment, the upper and lower ends of the case 86 are open. Intervention plates 86k and 86m may be disposed as necessary so that the homogeneity of the fuel inside the case 86 and the circulation property inside and outside the case 86 are balanced. The liquid level inside the case 86 and the liquid level outside the case 86 are maintained to be the same. The pair of liquid level-sensitive electrodes 81 is disposed on a surface 82m (i.e., on the right side in the figure) of the liquid level sensor substrate 82. The fuel discharged from the pressure regulator 40 into the case 86 will flow down along the surface 82h (i.,e., on the left side in the figure) of the liquid level sensor substrate 82 and will not flow down along the right-side surface 82m in the figure. In a portion located above the liquid level inside the case 86, fuel will not cover the pair of liquid level-sensitive electrodes 81. Thus, the fuel flowing down along the liquid level sensor substrate 82 will not cause an error in the liquid level measurement result. As shown in FIG. 10, the pair of liquid level-sensitive electrodes 81 extends to reach the lowest portion of the liquid level sensor substrate 82.

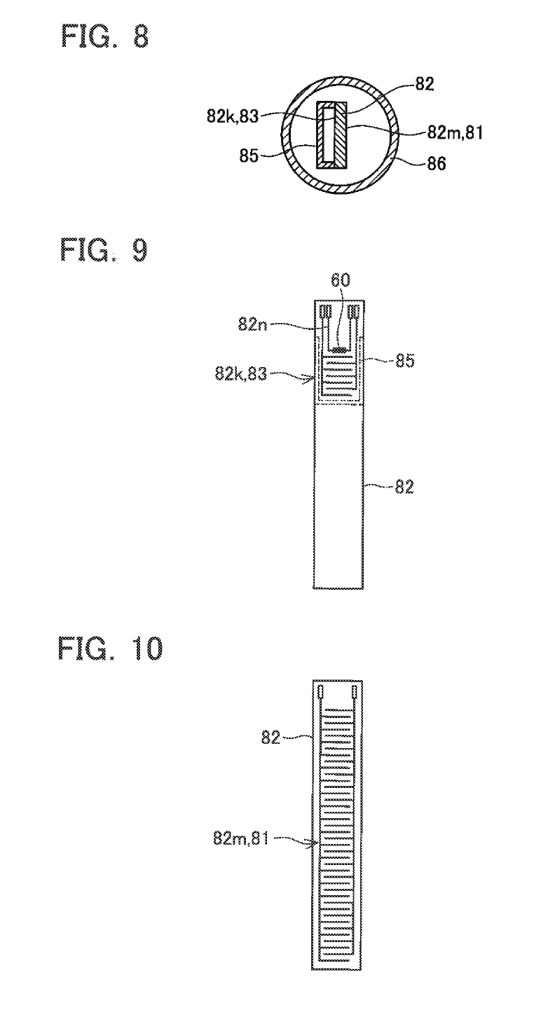

In the embodiment of FIG. 7, the pair of liquid level-insensitive electrodes 83 is formed on the left-side surface 82h in the figure, of the liquid level sensor substrate 82. To allow the pair of liquid level-insensitive electrodes 83 to be normally immersed in fuel, a fuel pool 85 is formed on the left-side surface 82h in the figure, of the liquid level sensor substrate 82. As shown in FIGS. 7 and 8, the fuel pool 85 forms a bottomed cylindrical shape together with the liquid level sensor substrate 82. As shown in FIG. 9, the pair of liquid level-insensitive electrodes 83 is formed in a portion that forms the side wall of the fuel pool 85. The pair of liquid level-insensitive electrodes 83 is immersed in the fuel gathering in the fuel pool 85. In a case where the liquid level inside the fuel tank 10 is low, the fuel discharged from the pressure regulator 40 into the case 86 flows into the fuel pool 85. Even when the liquid level inside the fuel tank 10 is low, fuel gathers in the fuel pool 85, and the pair of liquid level-insensitive electrodes 83 is immersed in the fuel. The pair of liquid level-insensitive electrodes 83 measures a value that is not associated with the liquid level inside the fuel tank 10. The permittivity of fuel can be measured from the measured value. By using the permittivity information, the measurement result obtained using the pair of liquid level-sensitive electrodes 81 can be converted into a liquid level.

A temperature measuring portion 82n may be disposed in the fuel pool 85. 60 in the figure is a thermistor. The permittivity of fuel can be measured using the pair of liquid level-insensitive electrodes 83. The permittivity of fuel changes according to the alcohol content of fuel and the temperature. The temperature measuring portion 82n allows the measurement result of the pair of liquid level-insensitive electrodes 83 to be converted into an alcohol content.

In a case where the fuel discharged from the pressure regulator 40 returns to the case 86 from above the ease 86, the fuel is controlled to flow out of the case 86 from below the case 86. In a case where the fuel discharged from the pressure regulator 40 returns to the case 86 from below the case 86, the fuel is controlled to flow out of the case 86 from the side wall of the case 86. In this manner, the homogeneity of the fuel inside the case 86 and the circulation property inside and outside the case 86 are balanced.

The fuel pool 85 is configured to allow the pair of liquid level-insensitive electrodes 83 to be immersed in fuel and simply needs to have a fuel storing capability. The pair of liquid level-insensitive electrodes 83 may be covered with a material such as sponge or fiber capable of

### Fifth Embodiment

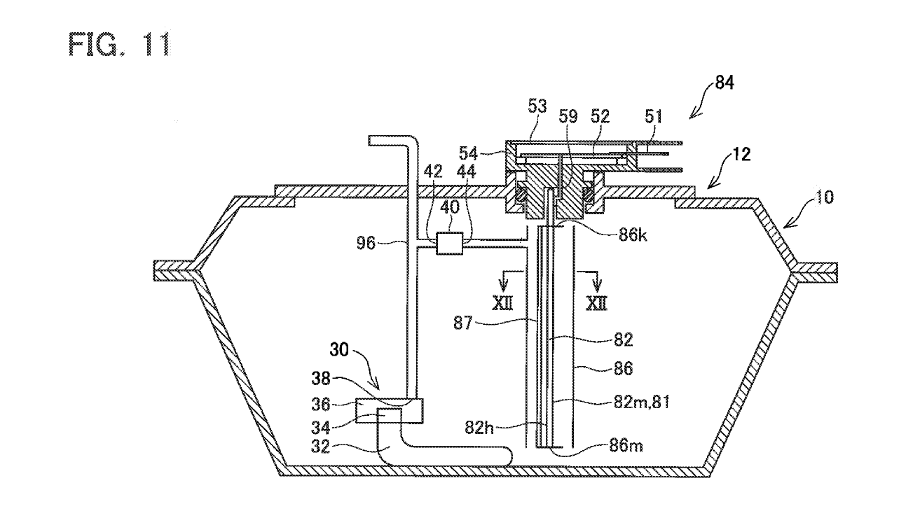

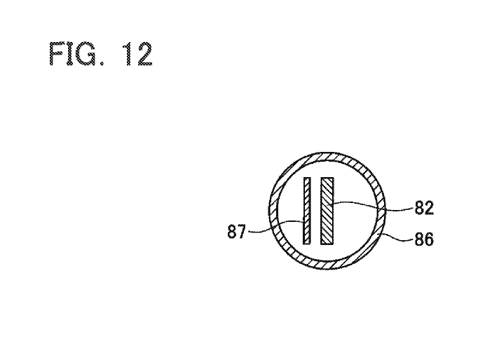

As shown in FIGS. 11 and 12, an interference wall 87 may be disposed between the liquid level sensor substrate 82 and a fuel return port of the case 86. In this case, the interference wall 87 prevents the fuel returning to the case 86 from directly colliding with the substrate 82. The fuel around the pair of electrodes formed in the liquid level sensor substrate 82 moves slowly. Bubbles may be mixed into the fuel discharged from the pressure regulator 40 into the case 86. The interference wall 87 prevents bubbles from adhering to the liquid level sensor substrate 82. The interference wall 87 also prevents bubbles from adhering to the liquid level sensor substrate 82 to cause an error in the measurement result.

The interference wall 87 may be formed of a fuel non-permeating material and may be formed of a fuel permeating material.

### Sixth Embodiment

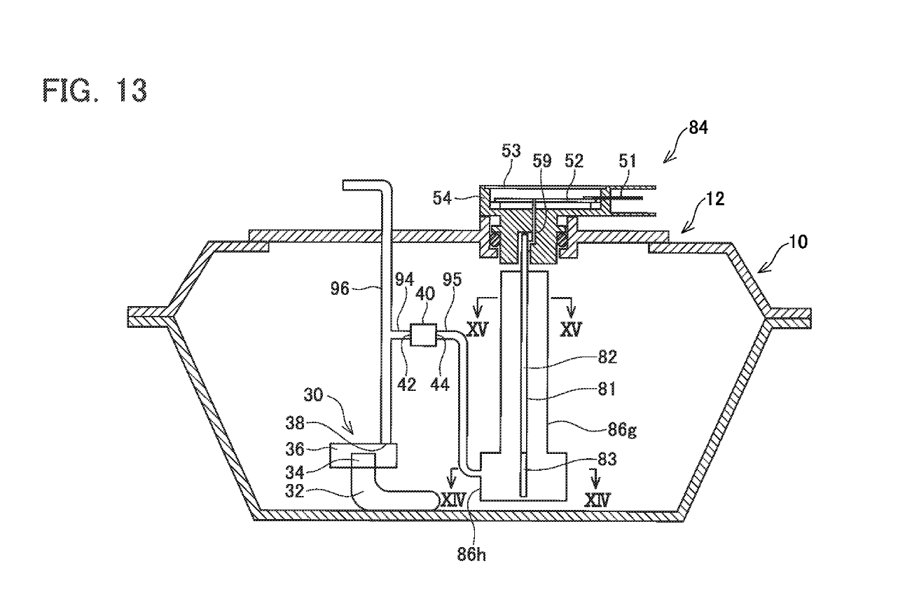

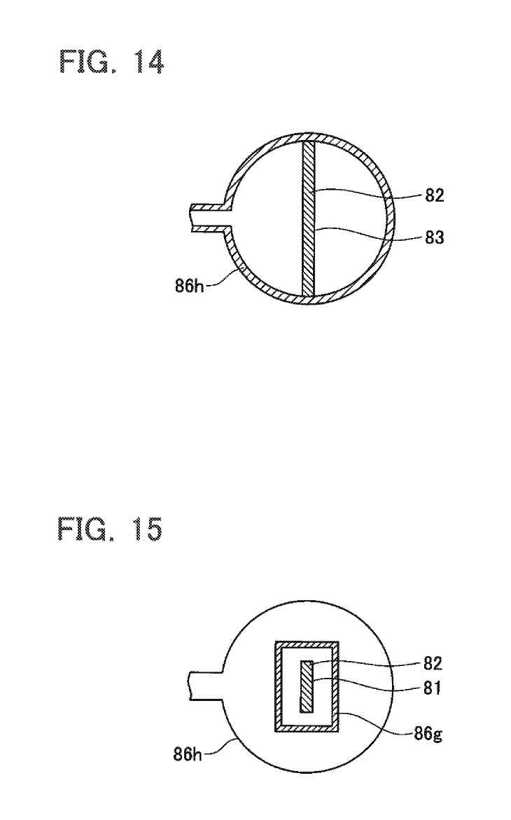

The fuel returned from the pressure regulator 40 into the case 86 and the fuel present in the case 86 may be forcibly stirred so that the stirred and homogenized fuel reaches the pairs of electrodes 81 and 83. As shown in FIGS. 13 to 15, in the sixth embodiment, the fuel discharged from the pressure regulator 40 is returned to the vicinity of the lower end of the case 86, and the fuel discharged from the pressure regulator 40 is received in a large capacity portion. The large capacity portion serves as a stirring chamber 86h that forcibly stirs the fuel returned from the pressure regulator 40 into the case 86 and the fuel present in the case 86. The stirred and homogenized fuel enters a case upper portion 86g.

The pair of liquid level-insensitive electrodes 83 is formed in a portion of the liquid level sensor substrate 82 located inside the stirring chamber 86h. The pair of liquid level-sensitive electrodes 81 is formed in a portion of the liquid level sensor substrate 82 located within the case upper portion 86g in which the fuel stirred in the stirring chamber 86h enters.

The pair of liquid level-sensitive electrodes 81 and the pair of liquid level-insensitive electrodes 83 may be formed on the left-side surface of the liquid level sensor substrate 82 or the right-side surface and may be distributed on the left and right-side surfaces. The substrate 82 that enters into the stirring chamber 86h may be configured to tightly contact the wall of the stirring chamber 86h to completely divide the stirring chamber 86h into left and right parts, and a gap may be left between the wails that define the substrate 82 and the stirring chamber 86h. The bottom of the case 86 on the right side of the substrate 82 is preferably removed. When the pair of liquid level-insensitive electrodes 83 is formed on the right-side surface of the liquid level sensor substrate 82 within the stirring chamber 86h, it is preferable to decrease the area of a communication hole that communicates with the inside and outside of the case 86. It is also preferable to adjust the opening area of the communication hole such that the fuel inside the case 86 is quickly homogenized and the liquid levels inside and outside the case 86 are maintained to be the same.

### Seventh Embodiment

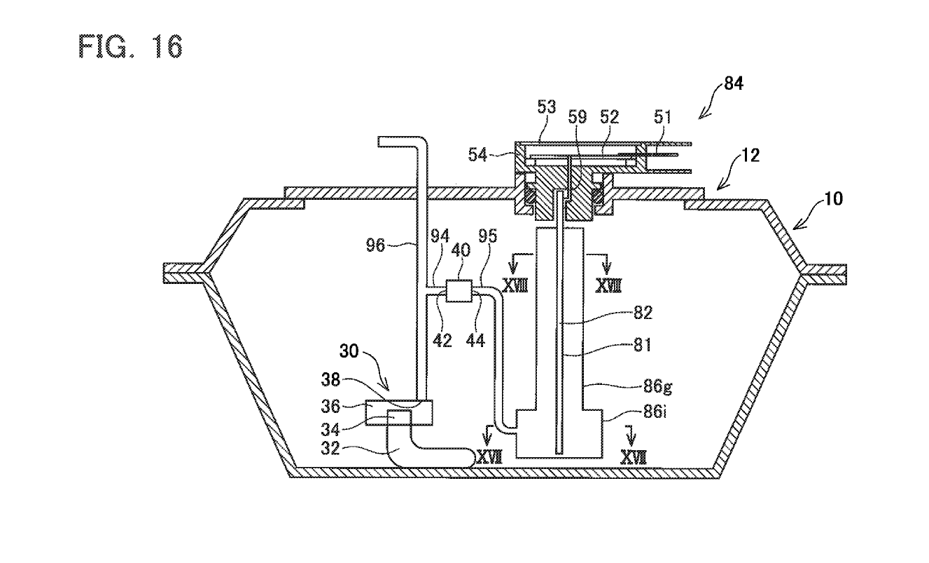

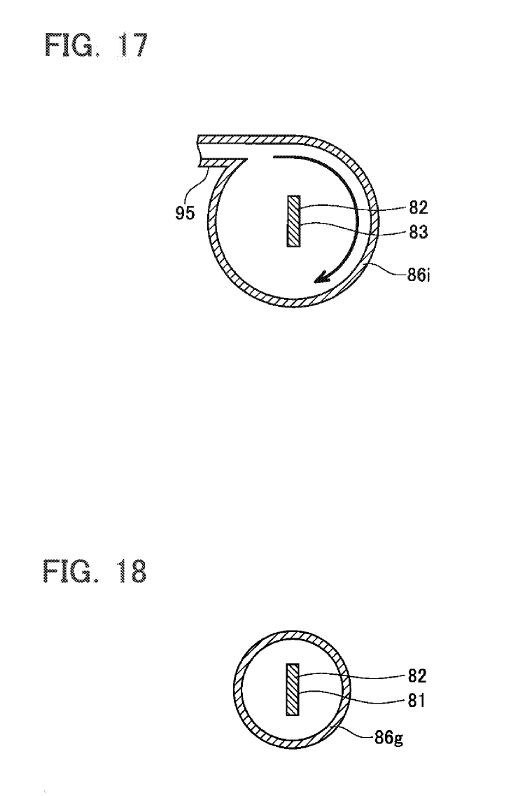

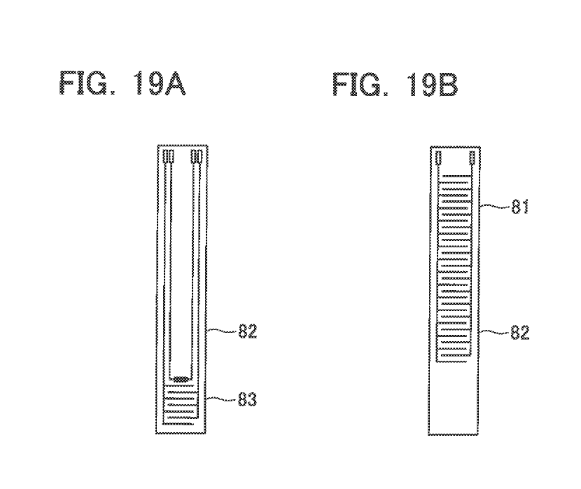

As shown in FIGS. 16 to 19B, a rotational flow may be generated in a stirring chamber 86i so that the homogenization of fuel is accelerated. That is, as shown in FIG. 17, the stirring chamber 86i is configured to have a circular cross-section so that the fuel discharged from the pressure regulator 40 flows in from a tangential direction of the stirring chamber 86i. In this case, as shown in FIGS. 19A and 19B, it is preferable that the pair of liquid level-insensitive electrodes 83 is located within a height range of the stirring chamber 86i, and the pair of liquid level-sensitive electrodes 81 is formed in such a height range that the stirred and homogenized fuel enters into the stirring chamber 86i. Moreover, as shown in FIG. 18, it is preferable that the case upper portion 86g surrounding the pair of liquid level-sensitive electrodes 81 has a circular cross-section. In this case, a rotational flow is easily developed in the stirring chamber 86i, and the developed rotational flow smoothly enters into the case upper portion 86g.

### Eighth Embodiment

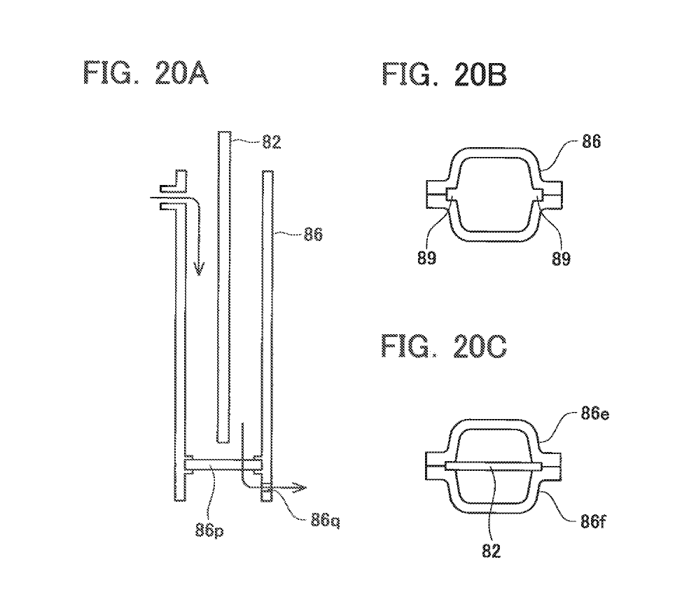

FIGS. 20A to 20C show a relationship between the case 86 and the liquid level sensor substrate 82 according to the eighth embodiment. As shown in FIG. 20B, a pair of grooves 89 is formed on the inner surface of the case 86. The pair of grooves 89 is formed at such a position that the cross-section of the case 86 is divided into two parts and extends in the vertical direction. When the left and right ends of the liquid level sensor substrate 82 are inserted in the pair of grooves 89, the left and right edges of the liquid level sensor substrate 82 are supported by the case 86. Thus, an operation of assembling the case 86 and the liquid level sensor substrate 82 can be simplified.

Alternatively, as shown in FIG. 20C, halved components 86e and 86f may be combined to form the case 86. In this case, the left and right edges of the liquid level sensor substrate 82 are inserted and fixed between the components 86e and 86f. Accordingly, the liquid level sensor substrate 82 can be made as thin as a flexible film, for example. Thus, the thin and flexible liquid level sensor substrate 82 can be laid out by the case 86.

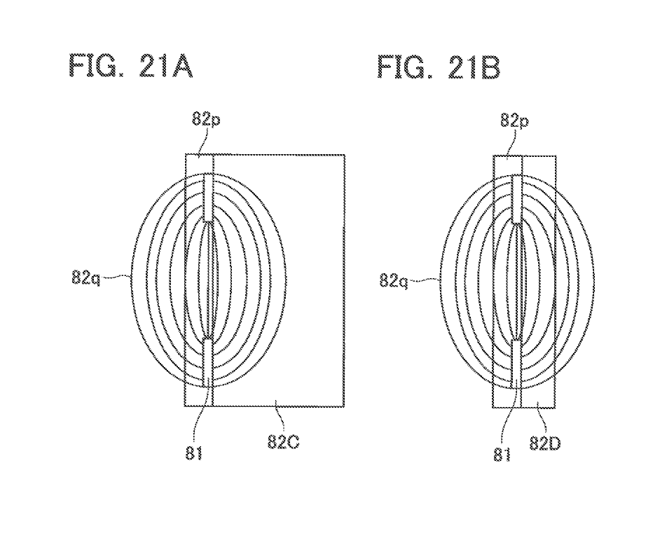

In a case where the liquid level sensor substrate 82 is made thin, the liquid level sensitivity is improved. FIG. 21 A shows a case where the liquid level sensor substrate 82 is thick, and FIG. 21B shows a case where the liquid level sensor substrate 82 is thin. An insulation sheet 82q covers the surface of the electrodes, and the lines of electric field are indicated by 82q.

In a case where the liquid level sensor substrate 82 is thick, the electric field developed between a pair of electrodes is absorbed by the substrate and does not pass through the fuel on the rear side of the substrate. Only the electric field on the front side of the substrate changes with the liquid level. In contrast, when the liquid level sensor substrate 82 is thin, the electric field developed between a pair of electrodes passes through the substrate to pass through the fuel on the rear side of the substrate. The electric field on the front and rear sides of the substrate changes with the liquid level. Thus, when the liquid level sensor substrate 82 is made thin, the liquid level sensitivity is improved. The supporting structure of FIG. 20C is suitable for making the liquid level sensor substrate 82 thin to improve the liquid level sensitivity.

### Ninth Embodiment

The ninth embodiment shown in FIG. 22 will be described. Overlapping description of the same portions as those of the first embodiment of FIG. 1 will not be provided. In this case, the pressure regulator 40 is fixed to the set plate, and the permittivity measuring device 50 is disposed at a position adjacent to the pressure regulator 40. The permittivity measuring device 50 comprises a fuel passage chamber in which the pair of liquid level-insensitive electrodes 83 is disposed.

In the ninth embodiment, a reserve cup 20 is fixed to the set plate 12 by a support 22. A jet pump 90 is disposed at the bottom of the reserve cup 20. The jet pump 90 sends the fuel outside the reserve cup 20 into the reserve cup 20 by utilizing the speed of the fuel that is pumped from the fuel pump 30 and discharged from the pressure regulator 40. For example, the jet pump 90 has a venturi structure so that when fuel discharged from the pressure regulator 40 passes through the venturi structure, the fuel outside the reserve cup 20 is sucked into the jet pump 90 as indicated by arrow 92, and the fuel sucked from the outside of the reserve cup 20 is sent into the reserve cup 20 together with the fuel discharged from the pressure regulator 40. As a result that the reserve cup 20 and the jet pump 90 are included, it is possible to maintain a high liquid level around the fuel pump 30 even when the amount of fuel remaining in the fuel tank 10 is small.

In the present embodiment, the fuel that is discharged from the pressure regulator 40 and passed through the permittivity measuring device 50 is delivered to the case 86 through a fuel pipe 93. Although the pair of liquid level-insensitive electrodes 83 is disposed outside the ease 86, since the fuel having passed through the pair of liquid level-insensitive electrodes 83 is delivered to the case 86, the fuel present around the pair of liquid level-insensitive electrodes 83 can be homogenized with the fuel present around the pair of liquid level-sensitive electrodes 81. It is sufficient for the ease 86 to homogenize the fuel in which the pair of liquid level-sensitive electrodes 81 is immersed in the depth direction, and the case 86 may not homogenize the fuel present around the pair of liquid level-insensitive electrodes 83 with the fuel present around the pair of liquid level-sensitive electrodes 81. This is because the latter homogenization can be realized by improvements other than the case 86.

### Tenth Embodiment

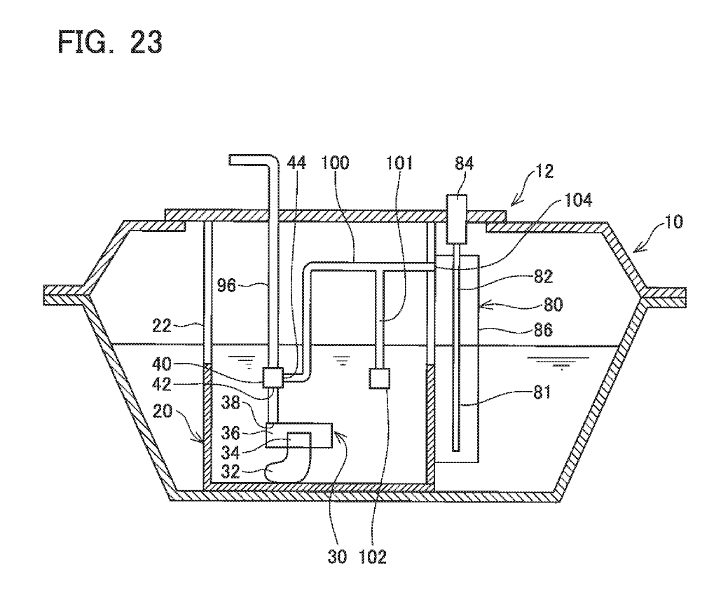

The tenth embodiment shown in FIG. 23 will be described. Overlapping description of the same portions as those of the first embodiment of FIG. 1 will not be provided. The pressure regulator 40 is disposed in a pipe 96. A pipe 100 is connected to the outlet port 44 of the pressure regulator 40. The liquid level measuring device 80 is connected to the pipe 100. A pipe 101 is connected to an intermediate position of the pipe 100. Due to this, the flow passage of the fuel discharged from the pressure regulator 40 branches into the pipe 100 and the pipe 101. The pipe 101 extends downward to the reserve cup 20. The lower end of the pipe 101 reaches inside the reserve cup 20. A stop valve 102 is disposed at an end (i.e., the lower end) of the pipe 101 closer to the reserve cup 20. The stop valve 102 may be an electromagnetic valve or an umbrella valve. When the stop valve 102 is an electromagnetic valve, the pipe 101 may be blocked after the elapse of a predetermined period after the fuel pump 30 is driven. The stop valve 102 blocks the pipe 101 when the liquid level of the fuel inside the reserve cup 20 reaches the stop valve 102 and opens the pipe 101 when the liquid level has not reached the stop valve 102.

In the present embodiment, a portion of the fuel discharged from the pressure regulator 40 flows into the case 86, and the remaining portion of the fuel discharged from the pressure regulator 40 flows into the reserve cup 20. According to this configuration, homogenized fuel can be discharged into the reserve cup 20. Moreover, fuel can be supplied into the reserve cup 20. Further, when the stop valve 102 blocks the pipe 101 so that the fuel is filled in the reserve cup 20, the fuel can be supplied to the case 86.

In the present embodiment, the case 86 may have any one of the shapes shown in FIGS. 3A to 3C. Moreover, the upper and lower ends of the case 86 may be open or blocked.

### Eleventh Embodiment

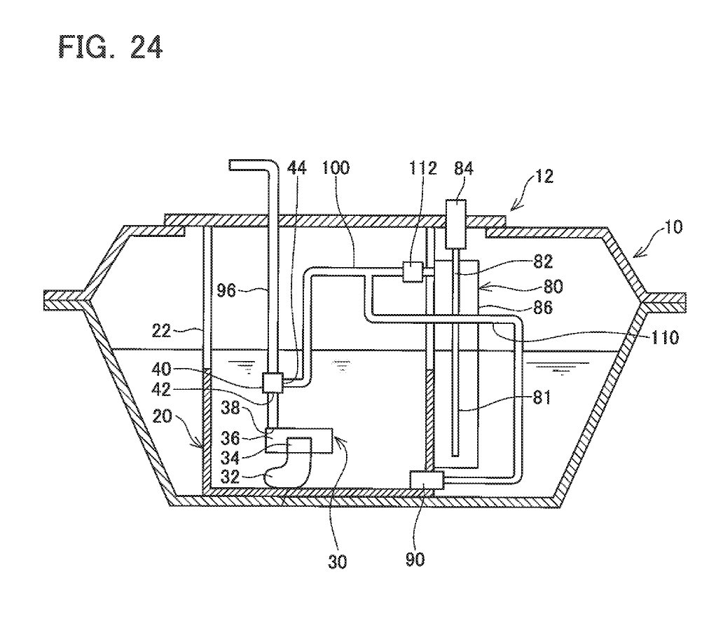

The eleventh embodiment shown in FIG. 24 will be described. Overlapping description of the same portions as those of the tenth embodiment of FIG. 23 will not be provided. A pipe 110 is connected to an intermediate position of the pipe 100. The pipe 110 is connected to the jet pump 90. Due to this, the flow passage of the fuel discharged from the pressure regulator 40 branches into the pipe 100 and the pipe 110. According to this configuration, it is possible to suck the fuel outside the reserve cup 20 into the jet pump 90 and to deliver the fuel sucked from the outside of the reserve cup 20 into the reserve cup ¹0 together with the fuel discharged from the pressure regulator 40.

A stop valve 112 is disposed in a portion of the pipe 100 closer to the case 86 than the branch point at which the pipe 110 branches off from the pipe 100. The stop valve 112 switches between a closed state where the stop valve 112 blocks the pipe 100 and an open state where the stop valve 112 opens the pipe 100. Specifically, when the pressure applied from the fuel in the pipe 100 to the stop valve 112 (i.e., the pressure of the fuel in the pipe 100) is smaller than a predetermined value (e.g., 200 Pa), the stop valve 112 is maintained in the closed state. Moreover, when the pressure of the fuel in the pipe 100 increases to the predetermined value or more, the stop valve 112 switches from the closed state to the open state, and the stop valve 112 is maintained in the open state for a period where the pressure of the fuel in the pipe 100 is maintained at the predetermined value or more. According, to this configuration, it is possible to suppress a decrease in the pressure of the fuel delivered to the jet pump 90. In a modification, a configuration (e.g., an aperture) for decreasing the flow passage area of the pipe 100 may be disposed in a portion of the pipe 100 closer to the case 86 than the branch point at which the pipe 110 branches off from the pipe 100 together with the stop valve 112 or instead of the stop valve 112.

Moreover, a stop valve may be disposed in the pipe 110. According to this configuration, fuel can be supplied preferentially to the case 86.

### Twelfth Embodiment

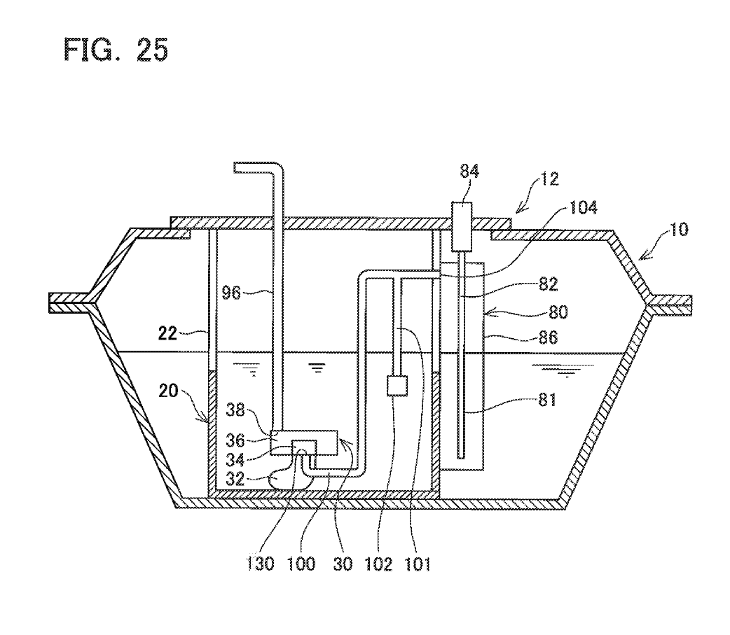

The twelfth embodiment shown in FIG. 25 will he described. Overlapping description of the same portions as those of the tenth embodiment of FIG. 23 will not be provided. The pipe 100 is connected to a vapor jet 130 of the fuel pump 30. The vapor jet 130 allows the fuel flow passage within the fuel pump 30 to communicate with the outside of the fuel tank 10. The vapor jet 130 is a communication passage for discharging bubbles of the fuel in the fuel pump 30 to the outside of the fuel tank 10. Fuel pressurized by the fuel pump 30 is discharged from the vapor jet 130. The fuel discharged from the vapor jet 130 flows into the pipe 100. The pipe 101 may be disposed near the lower end of the pipe 100, that is near the bottom of the reserve cup 20.

According to this configuration, since the fuel discharged from the vapor jet 130 is received into the case 86, the fuel inside the case 86 is quickly homogenized. Thus, it is possible to reduce an error included in the liquid level measurement result.

### Thirteenth Embodiment

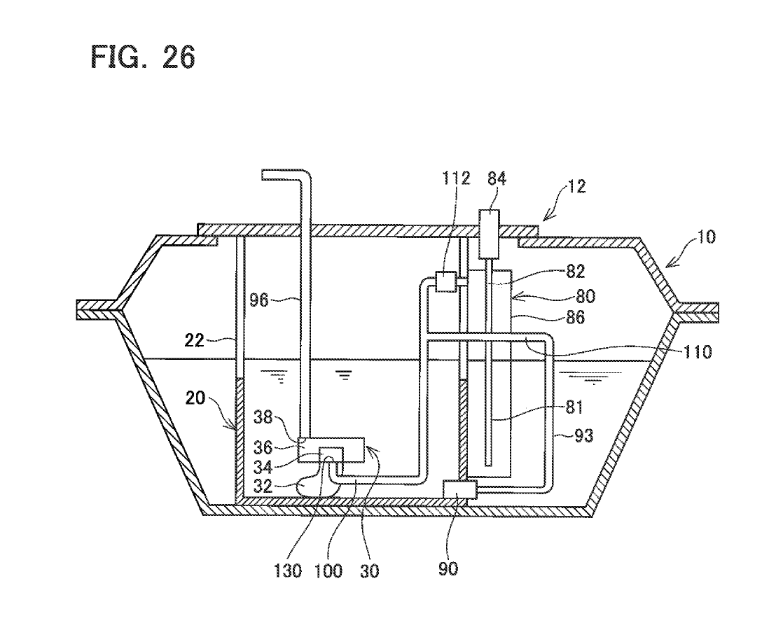

The thirteenth embodiment shown in FIG. 26 will be described. Overlapping description of the same portions as those of the eleventh embodiment of FIG. 24 will not be provided. The pipe 100 is connected to the vapor jet 130 of the fuel pump 30. According to this configuration, the same advantage as the twelfth embodiment is obtained.

### Fourteenth Embodiment

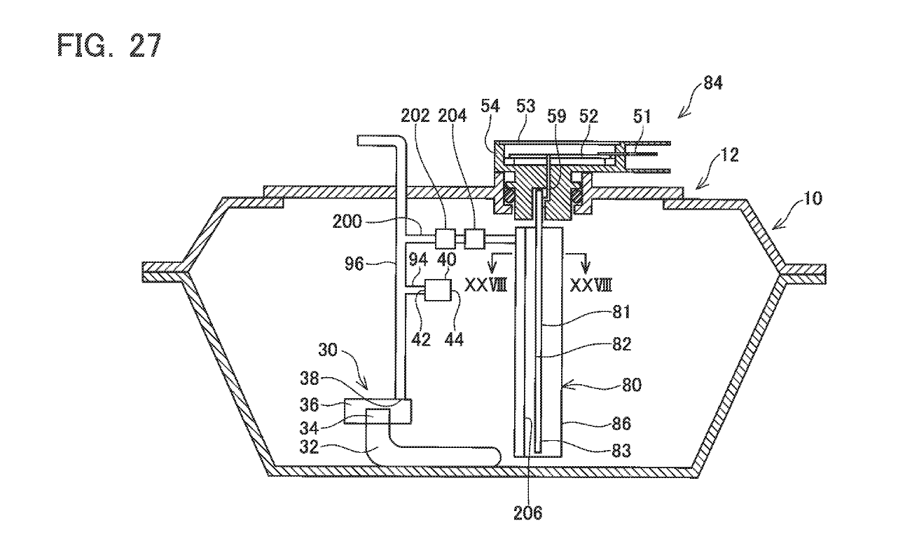

The fourteenth embodiment shown in FIG. 27 will be described. Overlapping description of the same portions as those of the first embodiment of FIG. 1 will not be provided. The pipe 95 is not connected to the outlet port 44 of the pressure regulator 40. Fuel is discharged into the fuel tank 10 from the outlet port 44 of the pressure regulator 40.

A pipe 200 is connected to an intermediate position of the pipe 96. That is, the pipe 200 branches off from the pipe 96. The liquid level measuring device 80 is connected to the pipe 200. Flow passage regulating portions 202 and 204 are disposed at an intermediate position of the pipe 200. The flow passage regulating portions 202 and 204 comprise a stop valve 202 and an aperture 204. The aperture 204 decreases the flow passage area of the pipe 200. Due to this, the flow passage area of the pipe 200 at the position where the aperture 204 is disposed can be decreased to be smaller than the flow passage area of the pipe 96. According to this configuration, it is possible to decrease the pressure of fuel in the pipe 200. The stop valve 202 switches between a closed state where the stop valve 202 blocks the pipe 200 and an open state where the stop valve 202 opens the pipe 200. Similarly to the stop valve 112, the side wall 202 switches between the closed state and the open state according to the pressure applied to the stop valve 202. Thus, it is possible to suppress a decrease in the amount of fuel supplied from the pipe 96 to the engine. In a modification, the pipe 200 may comprise only one of the aperture 204 and the stop valve 202. Moreover, the number of apertures and stop valves disposed in the pipe 200 is not particularly limited. Further, a valve of a type such as a valve which is electrically controlled to be open or closed may be used instead of the stop valve 202.

According to this configuration, since the fuel discharged from the pipe 200 is received into the case 86, the fuel in the case 86 is quickly homogenized. Due to this, it is possible to reduce an error included in the liquid level measurement result.

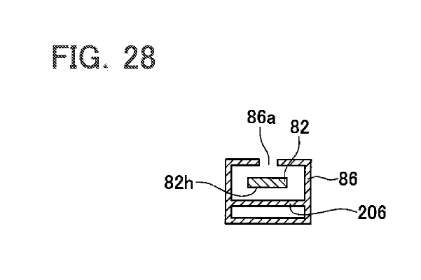

As shown in FIG. 28, an interference wall 206 is disposed in the case 86. According to this configuration, the same advantage as the interference wall 87 is obtained.

In a modification, a reserve cup may be disposed in the fuel tank 10. In this modification, a pipe that allows the pipe 200 to communicate with the jet pump may be disposed at an intermediate position of the pipe 200. The pipe 200 may be connected to the pipe between the stop valve 202 and the aperture 204. Due to this, it is possible to drive the jet pump with constant pressure and to discharge surplus fuel to the case 86. In another modification, alternatively, a pipe that is open to the reserve cup may be connected at the intermediate position of the pipe 200.

Modifications

(1) In the eleventh and thirteenth embodiments, a flow passage regulating portion may be disposed in the pipe 100. The flow passage regulating portion may comprise at least one of a stop valve and an aperture that decreases the flow passage area of the pipe 100.

(2) In the respective embodiments and modifications, the inner diameter of the pipes 100 and 200 may be smaller than the inner diameter of the pipe 96.

(3) The electrodes of the respective embodiments are not limited to the electrodes described in the respective embodiments. For example, the electrodes may be a pair of cylindrical electrodes and may be a pair of flat plate-like electrodes.

(4) in the eleventh to fourteenth embodiments, similarly to FIG. 22, the permittivity measuring device 50 that accommodates the pair of liquid level-insensitive electrodes 83 may be disposed.

What is claimed is:

1. A liquid level measuring device for measuring a liquid level of fuel stored in a fuel tank, the liquid level measuring device comprising:
the fuel tank that stores fuel;
a fuel pump that sucks the fuel in the fuel tank and pumps the fuel toward a combustion apparatus;
a fuel discharging portion that discharges the fuel from the fuel pump into the fuel tank;
a case that receives the fuel discharged from the fuel discharging portion; and
a pair of liquid level-sensitive electrodes that is accommodated in the case so as to measure capacitance that changes with the liquid level, wherein
the case has a fuel permeating property to equalize the liquid level inside the case and the liquid level outside the case.

2. The liquid level measuring device according to claim 1, wherein
the fuel discharging portion comprises a pressure regulator that is disposed between the fuel pump and the combustion apparatus and that regulates pressure of the fuel pumped toward the combustion apparatus to a predetermined value by discharging surplus fuel.

3. The liquid level measuring device according to claim 1, wherein
the fuel discharging portion comprises:
a branch passage that branches off from a fuel supply pipe that supplies lies fuel from the fuel pump to the combustion apparatus; and
a decompressing portion that decreases the pressure of the fuel in the branch passage.

4. The liquid level measuring device according to claim 1, wherein
the fuel discharging portion comprises a discharge passage that extends from a vapor jet disposed in the fuel pump to the inside of the fuel tank, and
the vapor jet is used for discharging vapor in the fuel pump, from the fuel pump into the fuel tank.

5. The liquid level measuring device according to claim 1, wherein
a pair of liquid level-insensitive electrodes that is immersed in the fuel is disposed in the case.

6. The liquid level measuring device according to claim 1, wherein
a penetration hole that extends in a vertical direction is formed in a wall that defines the case.

7. The liquid level measuring device according to claim 1, wherein
a penetration hole is formed in the vicinity of upper and lower ends of the case.

8. The liquid level measuring device according to claim 1, wherein
a wall that defines the case is formed of a material that has fuel permeating property.

9. The liquid level measuring device according to claim 1, wherein
the case communicates with a filter that filters the fuel sucked into the fuel pump.

10. The liquid level measuring device according to claim 9, wherein
a pair of liquid level-insensitive electrodes that is immersed in the fuel is disposed in the case, and
the pair of liquid level-insensitive electrodes is disposed in the filter.

11. The liquid level measuring device according to claim 1, wherein
an interference wall is disposed between the pair of liquid level-sensitive electrodes and a position at which the fuel discharged from the fuel discharging portion flows into the case.

12. The liquid level measuring device according to claim 11, wherein
the interference wall is formed of a material that has a fuel permeating property.

13. The liquid level measuring device according to claim 1, wherein
a stirring chamber that receives the fuel discharged by the fuel discharging portion and mixes the fuel with the fuel inside the case is formed in a portion of the case.

14. The liquid level measuring device according to claim 1, wherein
edges in a horizontal direction of a component in which the pair of liquid level-sensitive electrodes is formed are supported by the case.

15. The liquid level measuring device according to claim 1, wherein
the case is a member that has an electromagnetic shielding function.

16. The liquid level measuring device according to claim 1, further comprising:
a reserve cup that is disposed in the fuel tank so as to accommodate the fuel pump;
a first flow passage that discharges the fuel discharged from the fuel discharging portion into he reserve cup; and
a second flow passage that extends from the fuel discharging portion to the case.

17. The liquid level measuring device according to claim 16, further comprising:
a stop valve that is disposed in the first flow passage.

18. The liquid level measuring device according to claim 1, further comprising:
a reserve cup that is disposed in the fuel tank so as to accommodate the fuel pump;
a jet pump that delivers the fuel outside the reserve cup into the reserve cup by utilizing a flow rate of the fuel discharged from the fuel discharging portion;
a third flow passage that extends from the fuel discharging portion to the case; and
a fourth flow passage that extends from the fuel discharging portion to the jet pump.

19. The liquid level measuring device according to claim 18, further comprising:
a flow passage regulating portion that is disposed in at least one of the third flow passage and the fourth flow passage and comprises at least one of a valve and an aperture.

20. A liquid level measuring device for measuring a liquid level of fuel stored in a //fue comprising:
a fuel pump that sucks the fuel in the fuel tank and pumps the fuel toward a combustion apparatus;
a fuel discharging portion that discharges the fuel from the fuel pump into the fuel tank;
a case that receives the fuel discharged from the fuel discharging portion; and
a pair of liquid level-sensitive electrodes that is accommodated in the case so as to measure capacitance that changes with the liquid level, wherein
the case has a fuel permeating property so that the liquid level inside the case and the liquid level outside the case are equalized.
